(19) United States
(12) Patent Application Publication
(10) Pub. No.: US 2006/0078744 A1
(43) Pub. Date: Apr. 13, 2006

(54) Substrate having insulating layers to prevent it from warping and the method of making the same

(75) Inventors: Tsung-Neng Liao, Taichung Country (TW); Francis Chung Hwa Pan, Taichung City (TW); John Chungteh Pan, Taichung City (TW); Chun-Chi Lee, Taipei City (TW); Chih-Lung Chen, Taipei City (TW)

Correspondence Address: BIRCH STEWART KOLASCH & BIRCH, PO BOX 747, FALLS CHURCH, VA, 22040-0747, US

(73) Assignee: Forhouse Corporation

(21) Appl. No.: 11/285,306

(22) Filed: Nov. 23, 2005

Related U.S. Application Data
(63) Continuation-in-part of application No. 10/791,819, filed on Mar. 4, 2004, now abandoned.

(51) Int. Cl. B32B 27/36; B32B 27/00

(52) U.S. Cl. 428/412; 428/500

(57) ABSTRACT

A substrate has a substrate member, which is made of a polar material, such as Polymethyl methacrylate (PMMA), Methyl methacrylate/Styrene copolymer (MS) or Polycarbonate (PC), having a first side and a second side. On the fist side and the second side of the substrate member provided with an insulating layers respectively, wherein the insulating layers are made of a non-polar material with a low water absorption, such as Cyclic Olefin Polymer (COP) or Cyclic Olefin Copolymer (COC). The water absorption of COP or COC is less than the water absorption of PMMA, MS or PC to prevent the substrate member from warping while the substrate is heated at a single side. Two adhesive layers, which is made of a material with a chemical structure with a non-polar segment and a polar segment, such as olefin/acrylate copolymer, to bond the insulating layers on the substrate member.

This is a continuation-in-part application of Ser. No. 10/791,819 filed on Mar. 4, 2004.

### BACKGROUND OF THE INVENTION

1. Field of the Invention

The present invention relates generally to an optical device, and more particularly to a substrate, which has insulating layers thereon to prevent the substrate from warping.

2. Description of the Related Art

FIG. 1 shows a direct-light backlight unit 60 and the backlight unit 60 has a base frame 62 on which a reflector 64, lamps 66, a diffuser 68 and a cover 70 are mounted in sequence.

The conventional diffuser 68 is made of Polymethyl methacrylate (PMMA) or Polycarbonate (PC) that the materials have a greater water vapor permeability. In a standard test of ASTM D570, the water absorption of PMMA is 0.3% and the water absorption of PC is 0.2%.

As shown in FIG. 2, the diffuser 68 has a first side 681, which is a side oriented to the lamps 66, and a second side 682, which is a side opposite to the first side 681, and the water permeated in the diffuser 68 are shown as dots in FIG. 2. As shown in FIG. 3, while the lamps 66 are turned on, the first side 681 of the diffuser 68 is exposed in the light of the lamps 66 directly and the permeable water in the diffuser 68 at where adjacent to the first side 681 is evaporated to escape from the diffuser 68 via the first side 681. In such condition, the diffuser 68 has a greater vapor permeability at where adjacent to the second side 682 and a less vapor permeability at where adjacent to the first side 681. In other words, the diffuser 68 has various material properties at the fist side 681 and at the second side 682. In additional, the lamps 66 irradiate the fist side 681 of the diffuser 68 directly to make the temperature at the first side 681 is greater than the temperature at the second side 682. Both factors of the material property and the temperature variety at the fist side 681 and the second side 682 of the diffuser 68 make the diffuser 68 warping as shown in FIG. 4.

A simple solution for such problem is that the diffuser is made of a material having a less water vapor permeability. But such material is rather too expensive or the material property thereof not meeting the requirement of the diffuser.

Another solution is to coat films that have a less water absorption on both sides of the diffuser. Typically, such films are made of silicon dioxide (SiO₂). The required temperature of coating the silicon dioxide films on the diffuser is very high (typically higher than 220° C.) and the coating process must be taken in a vacuum stove. Such process is difficult and expensive, and more particularly, the high temperature would affect the material property of PMMA or PC.

### SUMMARY OF THE INVENTION

The primary objective of the present invention is to provide a substrate, which will not warp while the substrate is heated on a single side thereof.

The secondary objective of the present invention is to provide a substrate, which the process of fabricating the substrate is easier and under a lower temperature than the conventional process.

According to the objectives of the present invention, a substrate having a substrate member and insulating layers provided on both sides of the substrate, wherein the insulating layers are made of Cyclic Olefin Polymer (COP) or Cyclic Olefin Copolymer (COC), which has a less water vapor permeability.

### BRIEF DESCRIPTION OF THE DRAWINGS

FIG. 1 is an exploded view of a conventional direct-light backlight unit;

FIG. 2 is a sectional view of the diffuser of the direct-light backlight unit and the lamps, wherein the lamps are off;

FIG. 3 follows FIG. 2, showing the lamps being turned on to evaporate water in the diffuser;

FIG. 4 follows FIG. 3, showing the diffuser warped because the temperature variety on both sides thereof;

FIG. 5 is a sectional view of a preferred embodiment of the present invention;

FIG. 6 is a sectional view of the preferred embodiment of the present invention, showing how the insulating layer blocks the water in the substrate member from escaping, and

FIG. 7 is a sketch diagram of the method of making the substrate of the present invention.

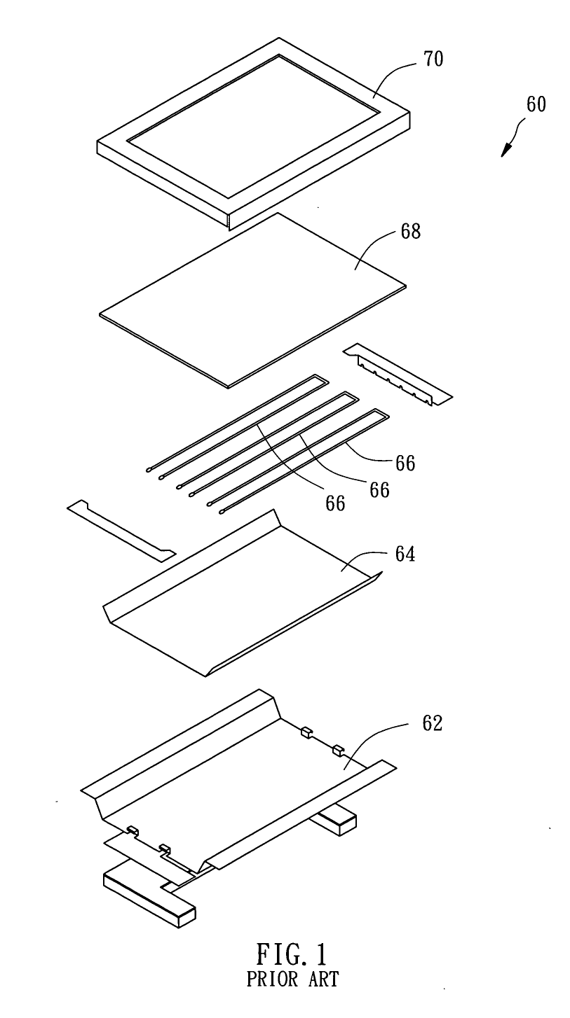

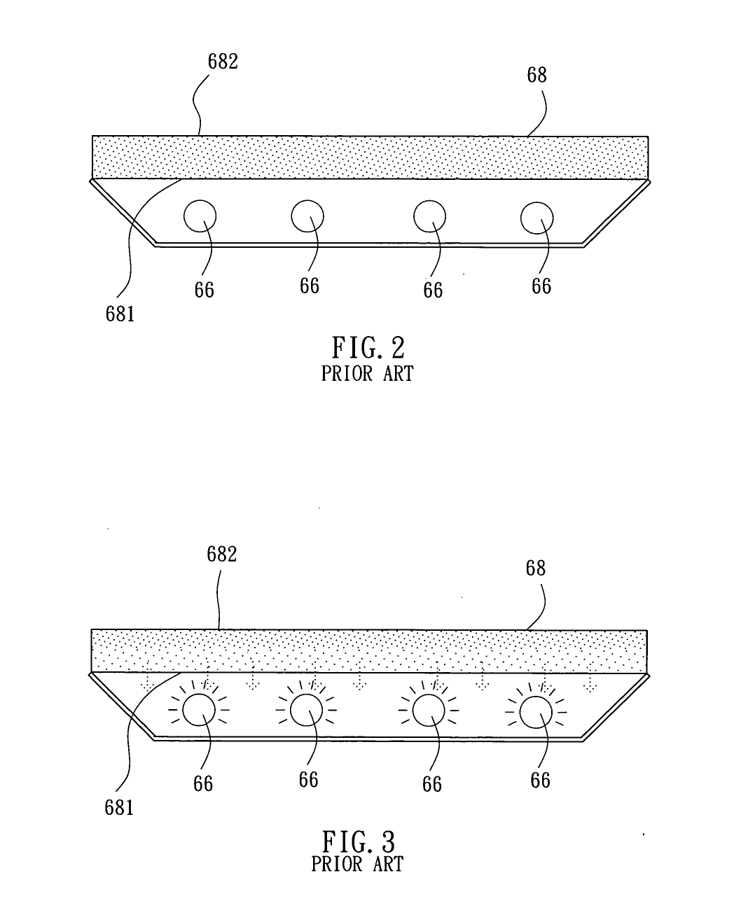

### DETAILED DESCRIPTION OF THE INVENTION

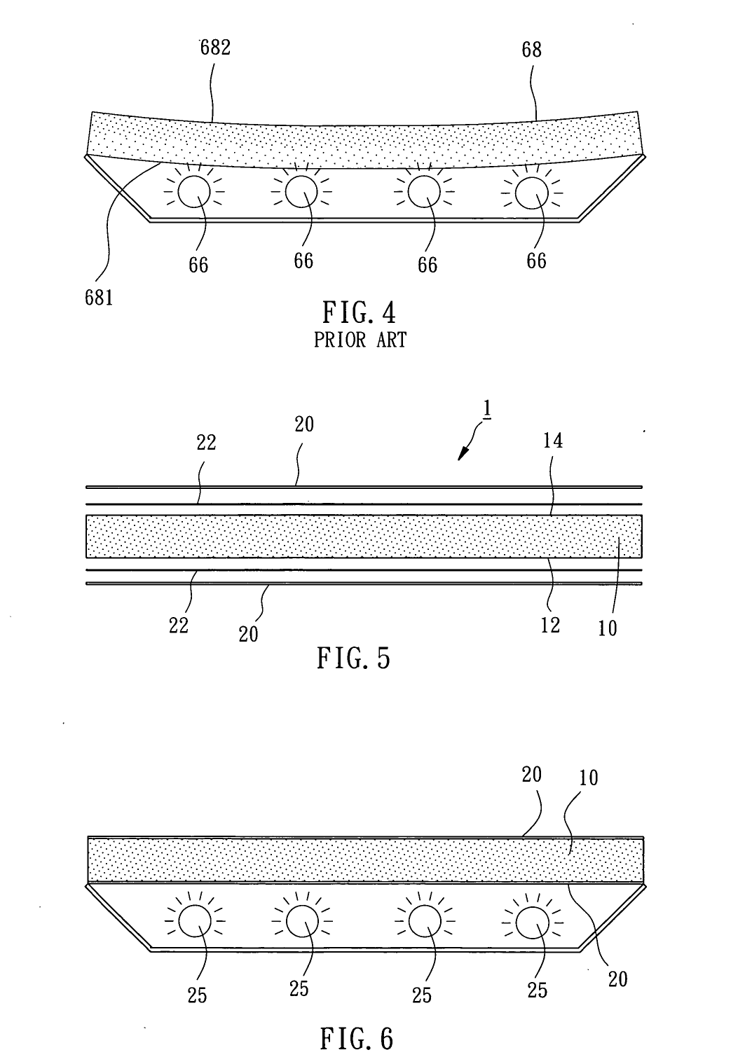

As shown in FIG. 5, the first preferred embodiment of the present invention provides a substrate 1 comprises a substrate member 10 having a first side 12 and a second side 14 and two insulating layers 20 provided on the fist and the second sides 12 and 14 of the substrate member 10 respectively. Two adhesive layers 22 are provided between the substrate member 10 and the insulating layers 20 respectively.

The substrate member 10 is made of Polymethyl methacrylate (PMMA), methyl methacrylate/styrene copolymer (MS) or Polycarbonate (PC). PMMA is broadly applied to modern life because that it is superior in optical property thereof and is cheap. Both of PMMA and PC are broadly applied to conventional automobile industry and architecture, furthermore, they are applied to compact discs, optical fibers, light guild plates or diffusers in the backlight units and other optical devices.

PMMA is a polar material, which the chemical structure is shown hereunder:

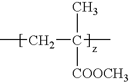

Methyl methacrylate/styrene copolymer is also a less polar material than PMMA, which the chemical structure is shown hereunder:

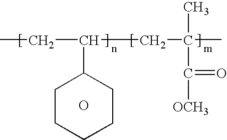

The insulating layers 20 are made of Cyclic Olefin Polymer (COP) shown as 2 types hereunder

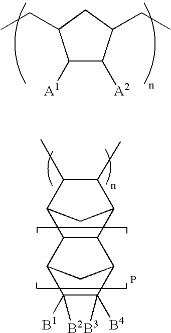

COC is synthesized (with Metallocene catalysts and MAO co-catalyst) by a co-polymerization process that reactants include cyclic olefin (eg. Noborene) and α-olefins (eg. ethylene) monomers. This thermoplastic have several special properties including clear and colorless, absorb almost no moisture and highly impermeable to water, low shrinkage, low birefringence, high thermal resistance, good dimension stability, low dielectric constant and excellent resistance to aqueous acids, bases or polar organics. The water absorption of COC, under the standard test of ASTM D570, is less than 0.01% that is less than the water absorption of PMMA (0.3%) and PC (0.2%).

COC is a non-polar material, which the chemical structure is shown hereunder:

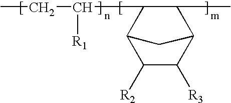

Basically, COC and COP are hard to be attached on the PMMA because that COC and COP are non-polar material, and the PMMA is polar material. The adhesive layers 22 are provided to help the lamination of COC (COP) and PMMA. The adhesive layers 22 have to be a material with polar segment and non-polar segment. In the present invention, the adhesive layers 22 are made of olefin/acrylate copolymer or its derivatives, for example, Ethylene/Methyl Acrylate copolymer (EMA), which the chemical structure is shown hereunder:

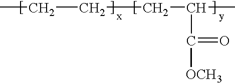

EMA has polar segment (COOCH₃) to be miscible with PMMA and non-polar segment (CH₂CH₂) to be miscible with COC (COP), such that EMA plays a perfect part of adhesive between COC (COP) and PMMA. The adhesion between PMMA/EMA or COC/EMA can be adjusted by the number ratio of these 2 kinds of repeating units, i.e. x/y value in chemical structure of EMA. Higher x/y value represents longer ethylene segments and thus a better adhesion between PMMA/EMA. The adhesion between COC/EMA can also be adjusted by the same way. The processability of EMA, for example, rheology or solubility, can be adjusted by either the molecular weight or x/y value as mentioned above.

The methods of how to provide the insulating layers 20 on the substrate member 10 have co-extrusion method, coating method and evaporation method etc. The coating method has dip coating, slit coating and spin coating. The evaporation method has chemical vapor deposition (CVD) and physical vapor deposition (PVD).

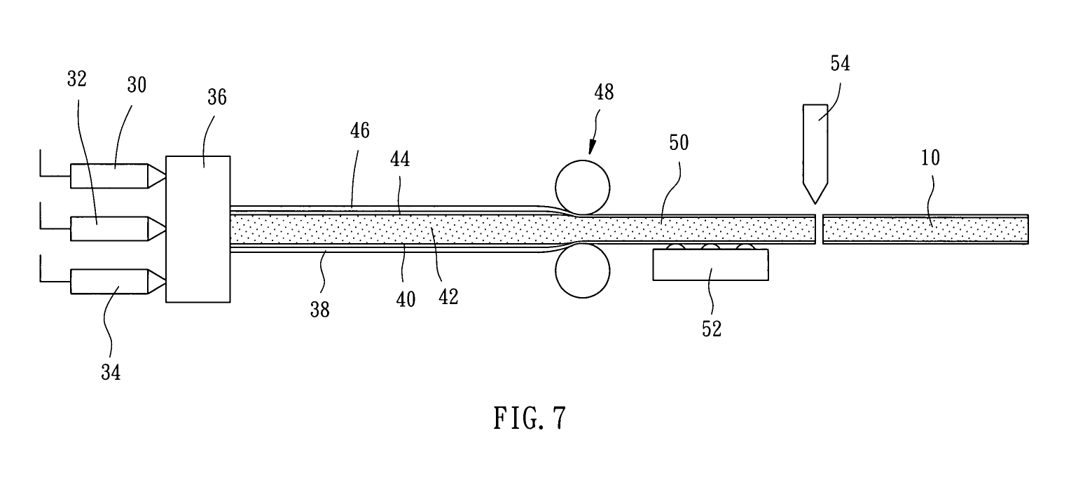

The present invention provides the co-extrusion method to fabricate the substrate. As shown in FIG. 7, PMMA, COC and EMA are provided to extruders 30, 32, 34 to extrude molten type PMMA, COC and EMA to an adapter 36. The adapter 36 has five channels (not shown) for the molten PMMA, COC and EMA flowing through respectively to form a laminated melt with five layers in a sequence of COC layer 38, EMA layer 40, PMMA layer 42, EMA layer 44 and COC layer 46. The melt is delivered to a rolling device 48, which controls the thickness of the melt and cools the melt as well. After passing through the rolling device 48, the melt is cooled by a conveyer roll 52 and forms a web 50. Then the web 50 is cut by a cutter 54 and the substrate 10 is produced as a result.

To achieve the scope of the present invention, the insulating layers 20 must have a thickness greater than 1 μm, and preferable, the thickness of the insulating layers 20 is between 50 μm˜200 μm.

As shown in FIG. 6, a single side of the substrate 1 of the present invention, which is the first side 12 of the substrate member 10 shown in FIG. 6, is heated by lamps 25 (or other heat sources). The insulating layers 20 block the water inside the substrate member 10 to prevent it from being evaporated and escaping out of the substrate member 10. Such that, the substrate 1 of the present invention keeps a homogeneous material property even if the substrate 1 is heated at a single side. As a result, the substrate 1 will not be warped while the temperature at a side of the substrate 1 is higher than the other side thereof.

The substrate of the present invention can be applied to the diffuser of the direct-light backlight unit, the light guild plate of the edge-light backlight unit, the protective plate of the window, the optical lens and the plate of architecture.

What is claimed is:

1. A substrate, comprising:
a substrate member, which is made of a polar material, having a first side and a second side;
a first insulating layer, which is made of a non-polar material with a water absorption less than 0.01%, attached on the first side of the substrate member;
a second insulating layer, which is made of a non-polar material with a water absorption less than 0.01%, attached on the second side of the substrate member; and
two adhesive layers between the substrate member and the first and second insulating layers, wherein the adhesive layers have a chemical structure with a non-polar segment and a polar segment.

2. The substrate as defined in claim 1, wherein the first and second insulating layers are made of Cyclic Olefin Polymer or Cyclic Olefin Copolymer.

3. The substrate as defined in claim 1, wherein the substrate member is made of polymethyl methacrylate, Methyl methacrylate/styrene coplymer, or Polycarbonate.

4. The substrate as defined in claim 1, wherein the adhesive layers are made of olefin/acrylate copolymer or its derivatives.

5. A method of making a substrate comprising the steps of:
Extruding a molten flow of a substrate member, which is made of a polar material, two molten flows of insulating layers, which are made of a non-polar material with a water absorption less than 0.01%, and two molten flows of adhesive layers, which are made of a material having a chemical structure with a non-polar segment and a polar segment;
laminating the molten flows by a sequence of the insulating layer, the adhesive layer, the substrate member, the adhesive layer and the insulating layer;
rolling and cooling the melt to form a web;
cooling the web; and
cutting the web to form the plates.

6. The substrate as defined in claim 5, wherein the insulating layers are made of Cyclic Olefin Polymer or Cyclic Olefin Copolymer.

7. The substrate as defined in claim 5, wherein the substrate member is made of Polymethyl methacrylate or Polycarbonate.

8. The substrate as defined in claim 5, wherein the adhesive layers are made of olefin/acrylate copolymer or its derivatives.
